(19) United States
(12) Patent Application Publication
(10) Pub. No.: US 2012/0031095 A1
(43) Pub. Date: Feb. 9, 2012

(54) ABSORBER PIPE FOR THE TROUGH COLLECTOR OF A SOLAR POWER PLANT

(75) Inventor: Andrea Pedretti, Bellinzona (CH)

(73) Assignee: Airlight Energy IP SA, Biasca (CH)

(21) Appl. No.: 13/143,116

(22) PCT Filed: Jan. 7, 2010
(86) PCT No.: PCT/CH10/00003

§ 371 Date: Aug. 30, 2011

(30) Foreign Application Priority Data
Jan. 8, 2009 (CH) 20/09

(51) Int. Cl. F24J 2/07; B21D 53/02; F03G 6/06; F24J 2/22; F24J 2/12

(52) U.S. Cl. 60/641.15; 126/675; 126/694; 126/648; 29/890.033

(57) ABSTRACT

The absorber pipe 10 according to the invention features a thermal opening 14, on which means are provided that reduce the radiation 26 emitted outwards from the absorbing surface 13 as a result of its operating temperature to an increasing extent as the operating temperature increases.

The present invention relates to an absorber pipe for a solar power station according to claim 1 and a method for its manufacture according to claim 12.

Solar thermal power stations have already been producing for some time power on an industrial scale at prices, which—compared with photovoltaic technology—are closer to today's customary commercial prices for power generated in a conventional manner.

In solar thermal power stations the radiation from the sun is reflected by means of collectors with the aid of a concentrator and systematically focused onto a location at which high temperatures arise as a result. The concentrated heat can be led away and used for the operation of thermal power machines such as turbines, which in turn drive the generators that generate the electrical power.

Today there are three basic forms of solar thermal power stations in use: dish-Sterling systems, solar tower power station systems, and parabolic trough systems.

Parabolic trough power stations feature a large number of collectors, which have long concentrators with a small lateral dimension, and thus possess not a focal point, but rather a focal line; this fundamentally differentiates this design from that of the dish-Sterling and solar tower power stations. Today these line concentrators feature lengths from 20 m up to 150 m, while the widths can be as much as 5 m or 10 m, or more. Along the focal line runs an absorber pipe for the concentrated heat (as a rule up to about 400° C.); the pipe transports this heat to the power station. A fluid such as, for example, thermo oil or superheated stream comes into consideration as the transport medium; this circulates in the absorber pipework.

Although a trough collector is preferably designed as a parabolic trough collector, trough collectors with spherical or only approximately parabolic designs of concentrators are often used, since an exact parabolic concentrator with the dimensions cited above can only be manufactured with great effort that is not really justified economically.

The 9 SEGS trough power stations in southern California together produce a power output of approximately 350 MW, and an additional power station in Nevada should be connected to the network at around the present time and deliver more than 60 MW. A further example of a trough power station is the Andasol 1 in Andalusia currently on trial, with a concentrator surface area of 510,000 square metres and a power output of 50 MW, with the temperature in the absorber pipework at approximately 400° C. The pipework system for the circulation of the heat-transporting fluid can in such power stations reach a length of up to 100 km or more if the design concepts for future large facilities are implemented. The costs for Andasol 1 total [symbol] 300 million.

It can be estimated that roughly 40% or more of the total costs for a solar power station fall upon the collectors and the pipework system for the heat-transporting fluid, and that the efficiency of the power station is decisively determined by the quality of the absorber pipework.

Conventional concentrators permit a concentration ratio in the range from 30 to 80, which leads to the desired high temperatures in the heat-transporting medium. Unfortunately this results in turn in a significant level of heat radiation from the absorber pipework that can reach 100 W/m, which for a pipework length of the order of the 100 km cited above significantly impairs the efficiency of the power station.

Accordingly the absorber pipework is increasingly being built in a more complex manner in order to avoid these energy losses. Thus widely used conventional absorber pipework is designed from glass and a metal pipe, with a vacuum present between glass and metal pipe. The metal pipe guides the heat-transporting medium in its interior, and on its outer surface is provided with a coating that absorbs the inward radiated light in the visible spectrum but features a low outward radiation rate for wavelengths in the infrared range. The encasing glass tube protects the metal pipe from cooling by wind and acts as an additional barrier for the outward radiation of heat. What is disadvantageous here is that the encasing glass wall both partially absorbs but also reflects the incident concentrated solar radiation, with the result that a coating is applied to the glass to reduce the reflection.

In order to reduce the laborious cleaning effort required for such absorber pipework, and also to protect the glass from mechanical damage, the absorber pipework can also be fitted with an encompassing mechanically protective tube, which, while it does have to be provided with an opening for the incident solar radiation, otherwise protects the absorber pipework in a very reliable manner.

Such structures are complex and accordingly expensive both in manufacture and also in maintenance. it is therefore the object of the present invention to provide absorber pipework of the type cited that can be used in a more cost-effective manner and with the highest possible temperatures of the heat-transporting fluid.

US PS 1 644 473 now shows an externally insulated absorber pipe with an absorber cavity extending lengthwise through the pipe internally, into which concentrated radiation enters via a similarly lengthwise running slot on the absorber pipe.

This allows the external face of the absorber pipe to be insulated effectively and at low cost in a simple manner, and thus to hold the heat losses at a low level compared with today's widely-used, complicated and maintenance-intensive designs. Moreover such a design is robust and simple to manufacture.

Furthermore in the document cited means are disclosed whereby the radiation that has entered through the slot into the absorber cavity is distributed by means of reflection over as much as possible of the total wall region of the absorber cavity, and thereby accordingly increases the absorbing wall surface at the expense of the slot opening. These means consist in the first instance of two deflecting mirrors positioned opposite to the slot opening, a collecting lens then preferably being arranged in the slot, which lens directs the collected incident radiation onto the deflecting mirrors. The radiation is then distributed by the mirrors over the wall surface. In another form of embodiment the absorbing wall of the absorber cavity is fitted with alternating peaks and troughs, on which the incident radiation is scattered by means of reflection and is thus similarly distributed over the whole wall surface.

A heat-transporting fluid flows around the absorbing wall of the absorber cavity and carries the heat away.

Absorber pipework of the type cited is now also to be improved beyond the object as set.

This object as set is achieved by means of an absorber pipe with the features of claim 1. A preferred form of embodiment of an externally insulated absorber pipe has the features of claim 3.

As a result of the means for reduction of the radiation emitted from the absorbing surface reducing the radiation emitted with increasing temperature of the absorbing surface to an increasing extent, or vice versa, reducing the radiation emitted less at a location of comparatively low temperature, the effort required to manufacture an absorber pipe can be reduced. The technical effort required to reduce the emitted radiation also climbs steeply with the operating temperature of the absorbing surface; this is of particular consequence if the temperature of the heat-transporting fluid increases above today's usual 400° C. to increase the efficiency of the power station and is to be provided for use on an industrial scale. According to the invention complex means for the reduction of the emitted radiation are concentrated at the exit side of the absorber pipe, i.e. in the region with high operating temperatures of the absorbing surface, and simple (or no) measures are provided for reduction of the emitted radiation at the entry side.

In the case of a conventional absorber pipe these can be assembled in the form of a kit of various modules, which are shielded in various ways against the emission of radiation. It is conceivable to have an entry side first section without any shielding, a middle section with some first, beneficial shielding, and a third exit side section with more complex, accordingly more effective, but also expensive and maintenance-intensive shielding. Such an arrangement noticeably reduces the costs of a collector field for a solar power station on an industrial scale.

For a preferred form of embodiment of an externally insulated absorber pipe designed according to the invention, there ensues:

As a result of the emergence of the radiation emitted from the wall of the absorber cavity being impeded, the efficiency of the absorber pipe increases; in that this takes place only in zones with a high operating temperature, the structure of the absorber pipe is simplified; despite the increased efficiency the pipe can still be manufactured comparatively cost effectively. The temperature of the wall of the absorber cavity basically increases linearly from the entry point for the heat-transporting fluid up to the exit, while the emission of the radiation increases exponentially with increasing temperature. In the entry region of the absorber pipe the radiation emission is therefore of little significance, but in its exit region it is of great significance.

Beyond the object as set the preferred form of embodiment of the present invention is particularly suitable for trough collectors with a spherically curved concentrator. Such concentrators do not generate a focal line, but rather a focal line region, which as such presupposes a comparatively wide thermal opening. Particularly in the case in which high temperatures are to be achieved in the wall of the absorber cavity for improved efficiency, a wide thermal opening is critical for a high efficiency on account of the radiation losses. According to the invention the radiation losses are now reduced where they occur, while where the radiation losses are low, the simple cost-effective structure with a wide thermal opening can be retained unmodified.

Thus there results in turn a relevant reduction of the manufacture, installation and maintenance costs of a solar power station with use of the absorber pipe according to the invention.

The features of preferred forms of embodiment are described in the dependent claims.

Further advantages of the absorber pipe according to the invention are described in more detail in conjunction with a preferred form of embodiment, as represented with the aid of the figures.

### IN THE FIGURES

FIG. 1 shows schematically a trough collector with an absorber pipe according to the prior art,

FIG. 2 shows a cross-section through an externally insulated absorber pipe with an internal cavity,

FIG. 3 shows a view of the absorber pipe according to the invention,

FIG. 4 shows a representation of the flux distribution of the concentrated radiation in the thermal opening, and

FIGS. 5a to 5d show the flux in the four different sections of the absorber pipe of FIG. 2, and

FIG. 6 shows a partial section through the absorber pipe designed according to the invention with an optical element.

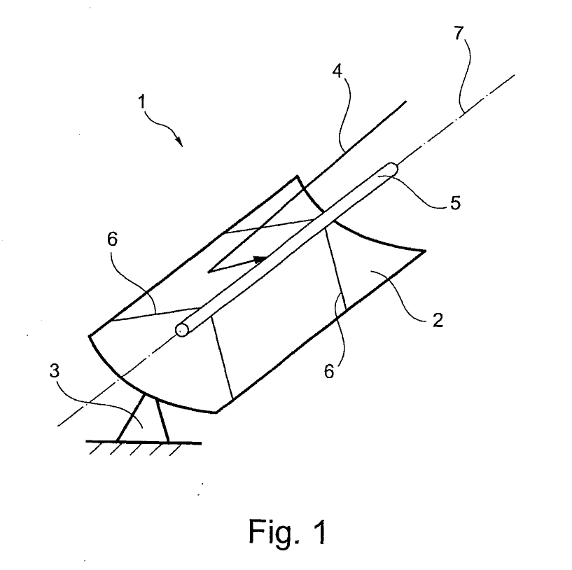

FIG. 1 represents a trough collector 1 of the type that finds application in its thousands, in the SEGS solar power stations, for example. A trough-shaped concentrator 2, in cross-section approximated as well as possible to a parabola, and designed as a mirror, rests on suitably designed struts 3. Solar radiation 4 is reflected from the mirror of the concentrator 2 and deflected onto an absorber pipe 5; the latter is sited at the location of the focal line 7 of the mirror. In the case where the curvature of the mirror is only approximate parabolic, in particular in the case where the curvature is spherical, a focal line region is formed instead of a focal line 7, with the result that the exterior of the absorber pipe receives incident radiation and is heated up over the whole of its cross-sectional dimension.

The absorber pipe 5 is suspended on suitable supports 6 at the location of the focal line or focal line region. Depending on the design the mirror is supported on the struts 3 such that it can pivot so that the mirror can track the seasonal (or even the daily) position of the sun.

In the absorber pipe 5 supplied fluid collects the heat introduced into the pipe by the concentrated solar radiation and transports this via a suitable, conventional pipework system (not represented in any further detail so as to simplify the figure) to the thermal machinery of the power station where the electrical power is generated.

Such trough collectors 1 are of known art in all details of the design to the person skilled in the art in a wide variety of forms of embodiment. Likewise the person skilled in the art is familiar with the suitable pipework runs that guide the heat-transporting fluid to and from the trough collector in question of a solar power station. As a rule, but not necessarily, the heat-transporting fluid is located in a circuit.

A wide variety of fluids are used for the heat transport; in particular fluids such as oil that possess a high thermal capacity are preferred. Hardly used at all—and definitely not for solar power generation on an industrial scale—are water or air, the latter because as a result of its comparatively low thermal capacity relative to its volume large volumes must be moved through the pipework system of the power station, which creates its own problems.

However, the use of oil or water, for example, is also not without its problems. In order to use the thermal capacity of the oil in an optimal manner, and to maintain the efficiency of the power station as high as possible, the oil is heated to a high temperature. A suitable circuit then runs, for example, at 390° C. and a pressure of 10 bar. In addition to the high costs of such an oil a further disadvantage is that the oil breaks down as soon as the temperature increases to 400° C., and thus complex temperature regulation is required. A water circuit can, for example, be operated at 300° C. and a pressure of 200 bar. While it is true that no denaturation of the water is to be feared at temperature peaks, the high pressures create design problems in the construction of the absorber pipework, while the thermal capacity is not as good as that of oil. Also the corrosive effect of the water, not least with the phase change from water to steam, is not to be underestimated.

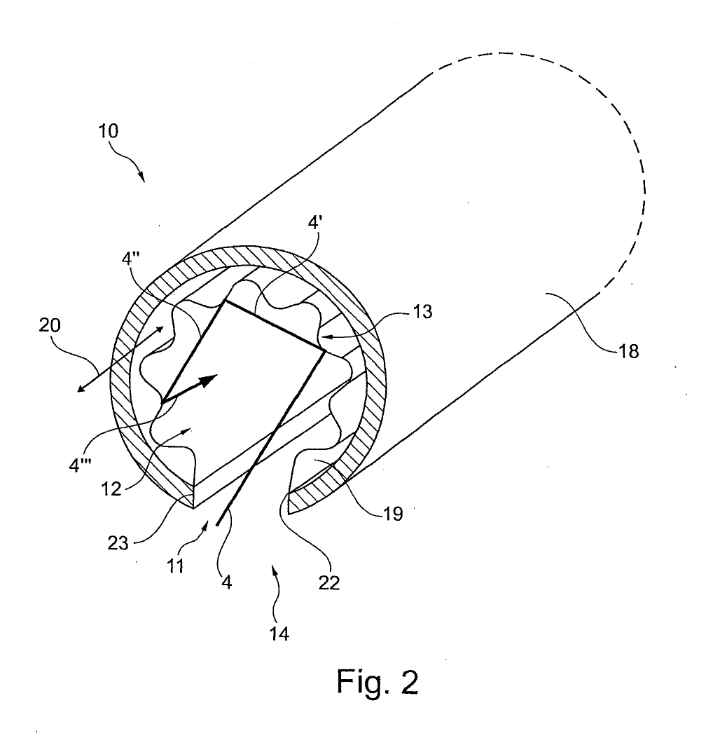

FIG. 2 shows in cross-section an externally insulated absorber pipe 10 in a form of embodiment preferred for the application of the present invention. A thermal opening 14 here designed as a slot 11 with edges 22, 23, running lengthwise along the absorber pipe 10 allows the passage of concentrated solar radiation through into the interior of the pipe 10, as represented in the figure in the example of a solar ray 4.

An absorber cavity 12 runs lengthwise in the interior of the absorber pipe 10 up to the absorbing wall 13, preferably designed as a thin-walled hollow profile with an essentially constant wall thickness.

A jacket 18 encases the absorber cavity 12 essentially concentrically, and such that a cavity 19 annular in cross-section is formed between the jacket and the absorbing wall 13; the cavity runs lengthwise through the absorber pipe 10.

The heat-transporting fluid (in the present case, for example, a gas) circulates through this annular cavity 19, which lies in an outer region of the absorber pipe 10, as is indicated by the double arrow 20 showing the possible directions of circulation.

In the form of embodiment shown in the figure the absorbing wall 13 is designed as a waveform profile in cross-section. As a result an incident concentrated solar ray 4, insofar as it is not absorbed by the absorbing wall 13, is multiply reflected (and in the process is each time partially absorbed) and thus the incident radiation is scattered, as represented in the example by its reflected components 4′ to 4′″. In this manner the energy introduced by the ray 4 is distributed over the whole region of the absorbing wall 13, with the result that the latter is distributed by the concentrated radiation 4 over its periphery and is thereby heated very evenly.

Under operational conditions the heat-transporting fluid flows continuously from the entry side of the absorber pipe to its exit side, the absorbing wall 13 being cooled most strongly at entry; correspondingly the operating temperature of the absorbing wall 13 is a minimum at entry, and then increases evenly up to the exit side, where it is a maximum.

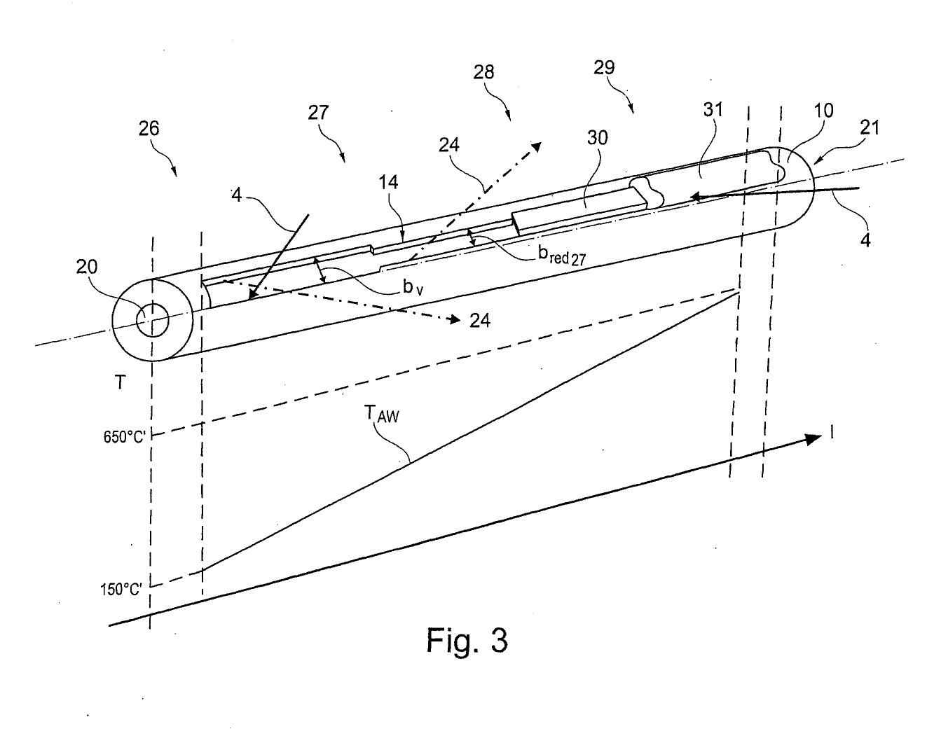

The heat-transporting fluid enters the absorber pipe 10, for example, with a temperature of e.g. 60° C., is heated up while passing through the latter and leaves with an exit temperature, which in the application of the present invention, e.g. in the case of air (or also other media), can lie at 650° C. The absorbing wall 13 is therefore most strongly cooled at entry and most weakly cooled at exit; in the present example its temperature T_{AW} at entry is 150° C., then increases linearly over its length and at exit is ultimately 650° C. (FIG. 3).

The jacket 18 features an insulating layer that impedes the transfer of heat from the absorber pipe 10 to its surroundings. Since this insulation does not have to be transparent for incident radiation, as is the case in a widely-used design in accordance with the prior art, it can simply (and thus also cost-effectively) and at the same time effectively, be executed e.g. in rock wool.

Overall the result is a robust and cost-effective design that can even be manufactured on-site during the construction of a solar power station, for example, in the desert with limited access. Simple transport and simple on-site installation, combined with a robust design, are features that are not to be underestimated in a technology, which in the nature of things also has to be used in sparsely populated regions that have little or no infrastructure.

FIG. 3 shows a view of the absorber pipe 10 of FIG. 2, looking onto its thermal opening 14. The entry-side connection 20 for heat-transporting fluid is schematically represented, while the exit of the absorber pipe 10 is designated as 21.

As mentioned with reference to FIG. 2, the absorbing wall 13 heats up in the form of embodiment here preferred from 150° C. at the entry side up to 650° C. at the exit side, see the representation of the operating temperature distribution T_{AW} of the absorbing wall 13 over the length l of the absorber pipe 10. Here it is to be noted that for an improved efficiency, in particular of the industrial power generating solar power stations, what is viewed today as a high concentration of solar radiation, in the present example 80 times (according to the invention even more), i.e. 80 suns, is desirable, as is also as high as possible a temperature of the heat-transporting fluid (and thus also of the absorbing wall 13) and therefore these should be aimed for.

Under operational conditions, i.e. at the operating temperature, the absorbing wall 13 now for its part radiates thermal radiation outwards, as is described below. This radiation is emitted outwards over the surface area of the thermal opening 14, thereby reducing the efficiency of the absorber pipe 10.

According to the Stefan/Boltzmann Law thermal radiation, essentially infrared radiation 24, is fundamentally emitted from any body, with the emission increasing with the fourth power of the temperature of the body. The emitted radiation W is given by W=σT⁴ W/m² and in the present case, with a temperature of the absorbing wall 13 of 650° C., corresponds to 40,000 W/m². Starting from the premise that the energy radiated from the sun onto the earth's surface corresponds to a flux of 1,000 W/m², it follows that this loss is equivalent to 40 suns. If ultimately the collector now achieves an 80 times concentration, this means an average flux of 80,000 W/m² (80 suns) of concentrated radiation 4 through the thermal opening 14 into the absorber cavity 12. At an absorbing wall 13 temperature level of 650° C. there now necessarily ensues at the same time a loss of 40 suns out of the opening 14, which corresponds to 50% of the concentrated radiation.

According to the invention means are now provided on the absorber pipe 10, which as a function of the operating temperature of the absorbing wall 13, rising over the length of the thermal opening, reduce the emergence of radiation 24 emitted outwards through the thermal opening. In FIG. 3 the thermal opening 14 is to this end subdivided over its length into four sections 26 to 29, which in each case have the following means:

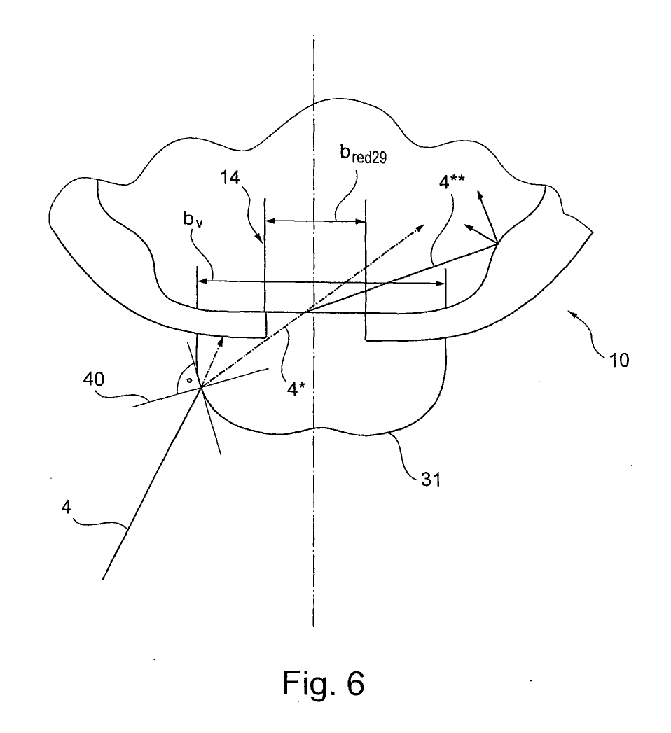

In the first section 26 no such means are yet provided, thanks to the still low temperature of the absorbing wall 13; the thermal opening 14 has its full width bᵥ, not a reduced width. In the second section 27 these means have a thermal opening with a reduced width b_{red 27}, in the third section 28 the thermal opening 14 is provided with a covering 30, which is transparent for radiation in the visible spectrum and is non-transparent, or of reduced transparency, for radiation essentially in the infrared range. Finally in the fourth region 29 an optical element 31 is arranged on the thermal opening 14 of reduced width b_{red 29}; this is designed to guide also such concentrated radiation 4 that is incident outside the thermal opening 14 of reduced width b_{red 29} by diffraction of the radiation path through the thermal opening 14 (FIG. 6). The optical element is preferably further designed such that the radiation 4 that is captured is incident in a width that corresponds to that of the thermal opening of non-reduced width bᵥ.

A covering of the thermal opening 14 in sections 26 and 27 can be dispensed with if the opening is directed downwards, since the hot air in the absorber cavity 12 does not flow out by means of convection, so that no heat loss takes place.

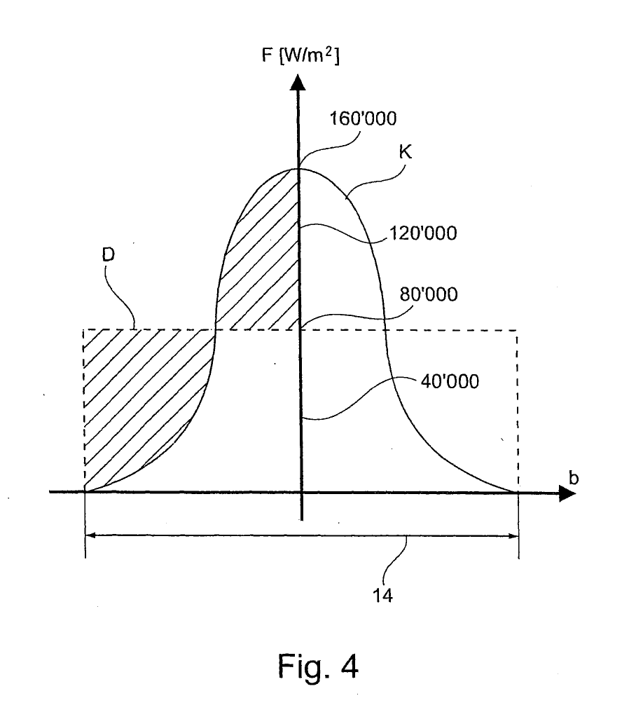

FIG. 4 now shows a general representation of the distribution K of the flux of the concentrated radiation 4 in the region and over the width of the thermal opening 14. In particular if the collector 2 (FIG. 1) is not curved parabolically, but spherically, a focal line region arises instead of a focal line; this in turn leads to a distribution K of the concentrated radiation 4 as represented in the figure. The largest proportion of the radiation is concentrated in a central region of the thermal opening 14, marked by the vertical axis F of the diagram; the peak value, in our example 160,000 W/m², is however limited to a very narrow region. This leads to the width b of the thermal opening 14 being designed to be as large as possible in order to capture the total concentrated radiation 4. An average value D of concentrated radiation 4 of 80,000 W/m² then ensues, and this enters through the thermal opening 14 into the absorber cavity 13 since the hatched regions in the figure are of equal area. In other words, by means of the concentrator 2 an 80 times concentration (or 80 suns) is achieved.

At this point it should be noted that the solar radiation incident onto the concentrator 2 (FIG. 1) is usually assumed to be parallel. The Sun's cone angle is approximately 0.5°, and this can be taken into account in the dimensioning of the width b of the thermal opening 14 and the flux of the concentrated radiation 4.

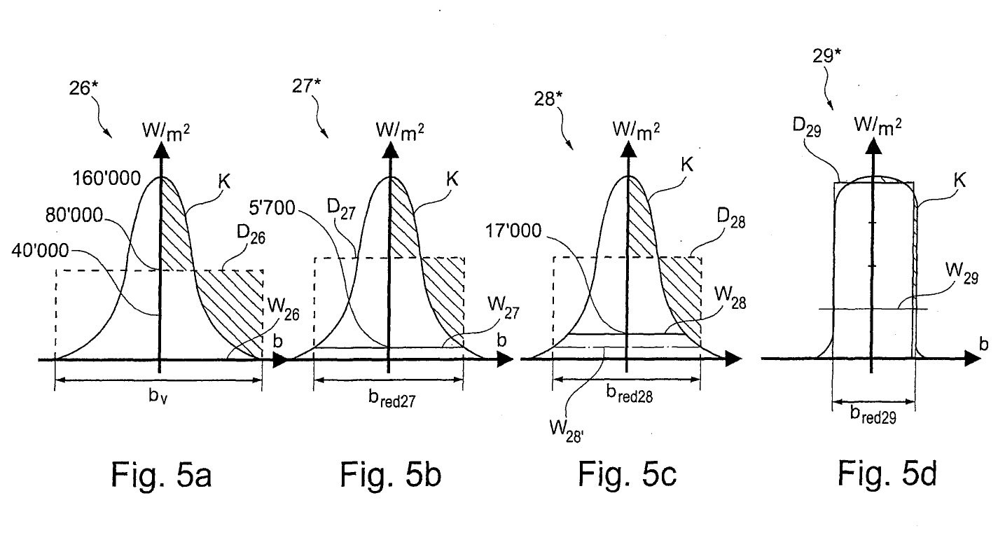

FIGS. 5a to 5d now show four diagrams 26* to 29*, corresponding in each case to the diagram of FIG. 4, and corresponding to the conditions in the sections 26 to 29 of the absorber pipe 10 (FIG. 3), while the flux W of the radiation 24 emitted from the absorbing wall 13 is also plotted. Since the absorbing wall 13 is heated essentially uniformly, the distribution W of the flux of radiation 24 is a horizontal straight line; the emitted radiation 24 exits over the whole width b of the thermal opening with an essentially uniform intensity.

If the direction of the concentrated radiation 4 is taken to be positive (into the pipe 10), the direction of the emitted radiation 24 is negative (out of the pipe 10). Accordingly the flux W should be indicated in the negative region of the vertical axis of the diagrams. To simplify the presentation, however, (and to show the intersection points of the distribution K with the flux W), W is plotted as a positive value.

Assuming a flux W=40,000 W/m² at 650° C., the following data apply:

| Section of the | Operating temperature of | Flux W of the radiation 24 |
|---|---|---|
| absorber pipe 10 | the absorbing wall 13 | emitted from the wall 13 |
| 26 | 150° C. | 133 W/m² |
| 27 | 275° C. | 5,700 W/m² |
| 28 | 400° C. | 17,000 W/m² |
| 29 | 650° C. | 40,000 W/m² |

In section 26 the flux W₂₆ is insignificant. The width b of the thermal opening 14 is therefore not reduced, and is determined as the full width bᵥ of the distribution K of the concentrated radiation 4. The conditions of FIG. 4 apply; the average flux D₂₆ through the opening 14 amounts to 80,000 W/m² or 80 suns.

In section 27 the flux W₂₇ is already significant. Accordingly the width of the thermal opening is here reduced according to the invention to the width b_{red 27}, such that within the width b_{red 27} the sum of the fluxes K+W (concentrated radiation 4 and emitted radiation 24) is at least zero at each point (which outside b_{red 27} would no longer be the case). Over each point of the width b_{red 27} more radiation enters in total than exits. Thus over the total width b_{red 27} a solely positive introduction of energy into the absorber chamber 12 ensues, in spite of the thermal emission W caused by the radiation 24. The average flux D₂₇ (see once again the hatched regions) amounts to more than 80,000 W/m² or 80 suns, so that in spite of the reduced width b_{red 27} the introduction of energy through the opening 14 is optimal.

In section 28 the flux W₂₈ is considerable. Here the additional effort of providing a covering 30 for the thermal opening 14 is worthwhile; this covering is transparent for radiation 4 essentially in the visible spectrum, and for radiation 24 essentially in the infrared range it is non-transparent or of reduced transparency. Accordingly the flux emitted from the absorbing wall 13 W₂₈ is reduced to the flux W_{28′} that actually exits through the opening 14; here the latter is crucial for the dimensioning of the width b_{red 28}, which in turn is dimensioned such that the sum of the flux F and the emitted radiation W is always at least zero???. Thus an optimised introduction of energy into the absorber chamber 12 also ensues in section 28.

In section 29 the flux W₂₉ is of critical importance. Here the additional effort of providing an optical element 31 on the thermal opening 14 is worthwhile; by diffraction of the radiation path the optical element guides the incident concentrated radiation 4 through the thermal opening 14. This has the result that the distribution of the concentrated radiation 4, after passing through the optical element 31, is modified compared with those in FIGS. 4, 5a to 5c. The distribution is now approximately uniform; by means of the optical element 31 the radiation 4 that is preferably captured is that incident in the region of the opening 14 over the non-reduced width bᵥ. This means that the quantity of energy that enters, now as before corresponds to the full power output of the concentrator 2 (FIG. 1), while the heat loss through the emitted radiation W, corresponding to the reduced width b_{red 29}, is massively reduced. The optical element 31 thus additionally concentrates the radiation 4 concentrated by the concentrator 2, the distribution of the flux F₂₉ being advantageously modified compared with those of FIG. 4 and FIGS. 5a to 5c as per the curve plotted in the figure.

To a first approximation the width b_{red 29} can basically be reduced to approximately 70 of the full width bᵥ. By the use of such an optical element 31 the advantage moreover ensues that an increased quantity of concentrated radiation 4 enters through the opening 14; this comes from the non-parallel solar radiation (cone angle of the solar radiation of approx. 0.5°, see above), and from solar radiation scattered at the concentrator 2 (FIG. 1). A diffractive index of 1.5 (glass) allows the width b_{red 29} to be further reduced, ultimately to approx. 50% of the full width bᵥ, while nevertheless energy corresponding to a concentration of 80 suns (parallel radiation) is received by the pipe 10. As a result, with an essentially unmodified high introduction of energy, corresponding to that in FIG. 5a, the energy loss W₂₉ can therefore be reduced by half. In section 29, therefore, despite the high temperature of the absorbing wall 13, the loss no longer amounts to 50% (corresponding to 40,000 W/m²) of the concentrated radiation 4 made available from the concentrator 2 (FIG. 1), but only 25%.

FIG. 6 shows a cross-section through a part of the absorber pipe 10 in section 29 at the location of the thermal opening 14. The absorbing wall 13, jacket 18, annular cavity 19 and optical element 31 are represented. A concentrated solar ray 4 impinges onto the optical element 31 and is diffracted towards the perpendicular 40, so that it passes as a ray 4* through the optical element 31 and as a ray 4** reaches the absorbing wall 13, where it is scattered into the absorber cavity 12. From the figure it can be seen that, as stated with regard to FIG. 5d, concentrated radiation is captured over the total width bᵥ and passes into the absorber chamber 12 via the width b_{red 29}. With a suitable design of optical element 31 this is true also for the non-parallel rays 4 of the sun. The shape of the optical element 31 can be graphically designed by the person skilled in the art and manufactured correspondingly. According to the invention the element that is then difficult to manufacture is arranged only in that section where the losses as a result of the emitted radiation 24 would otherwise be too high.

The example represented in FIGS. 4 and 5 relates to a preferred form of embodiment, depending on local conditions the person skilled in the art will suitably design and adapt the concentration factor of the concentrator 2 (FIG. 1), that is to say, the distribution of the flux of the concentrated radiation 4 in the region of the thermal opening (and also the latter itself). Thus the means for the reduction of the emitted radiation 24 (here the reduced width of the opening, the covering 30 and the optical element 31) can be suitably combined with one another, or other such means can also be provided. Likewise, for example, the width of the opening 14, instead of exhibiting a stepwise variation between the sections 26, 27, 28 and 29, can be continuously adapted to the rise in the operating temperature of the absorbing wall 13. Moreover the means according to the invention can be used at even higher operating temperatures than 650° C.

As a result it is possible to design an absorber pipe for higher and maximum temperatures of the heat-transporting fluid, without the effort required for this becoming prohibitive, since the means appropriate in each case are only provided at the efficiency-sensitive sections.

1. An absorber pipe for a solar power station with operating temperature increasing over its length, comprising:
means that reduce radiation emitted in an outwards direction from an absorbing surface as a result of its operating temperature as a function of the increasing operating temperature.

2. The absorber pipe according to claim 1, wherein the means for reduction of the emitted radiation are arranged after a first entry side section of the absorbing surface, and wherein means with a strongest reducing effect are provided on a last exit side section of the absorbing surface.

3. An externally insulated absorber pipe for a solar power station with an internal absorber cavity running lengthwise inside it according to claim 1, which can be reached by concentrated radiation via a similarly lengthwise running thermal opening on an absorber pipe, wherein means are provided, which as a function of the operating temperature of the absorbing wall of the absorber cavity, increasing over the length of the thermal opening, reduce the emergence of the radiation emitted in the outwards direction from the cavity through the thermal opening.

4. The absorber pipe according to claim 3, wherein the means reduce the emergence of the radiation emitted from the absorbing wall in stages and/or in a continuously increasing manner over the length of the thermal opening.

5. The absorber pipe according to claim 3, wherein the means have the thermal opening whose effective width is smaller in zones with a higher operating temperature of the absorbing wall.

6. The absorber pipe according to claim 4, wherein the effective width is reduced in at least one of stages and in a continuous manner.

7. The absorber pipe according to claim 3, wherein the means have a covering of the thermal opening, which is transparent for radiation essentially in a visible spectrum, and is non-transparent or of reduced transparency for radiation essentially in an infrared range.

8. The absorber pipe according to claim 3, wherein the means have an optical element, which on the thermal opening of reduced width is arranged and designed to guide radiation incident in a corresponding region of the thermal opening of preferably not reduced width through the thermal opening by diffraction of a radiation path.

9. The absorber pipe according to claim 5, wherein the thermal opening at one end of the absorber pipe has a first section with a maximum width, a middle section with a covering of reduced transparency for the essentially infrared radiation, and an optical element in a last section with reduced width.

10. A trough collector with the absorber pipe according to claim 1.

11. A solar power station with a trough collector comprising the absorber pipe according to claim 1.

12. A method for the manufacture of the absorber pipe according to claim 3 comprising:
from the assigned concentrator the distribution of the flux of the concentrated radiation is determined in the region of the thermal opening of the absorber pipe, and hence its maximum width
the operating temperature of the absorbing wall of the absorber cavity is determined over its length and hence the flux of the radiation emitted from it in the region of the thermal opening;
section-by-section over the length of the absorber pipe that width of the thermal opening is determined within which the flux of the concentrated radiation is at least equal to the flux of the emitted radiation; and
the thermal opening of the absorber pipe is designed with the width thus determined, over at least a first lengthwise section.

13. The method according to claim 12, wherein the flux of the emitted radiation is reduced over at least one lengthwise section of the thermal opening by means of an optical element, which is essentially transparent for concentrated radiation.

14. The method according to claim 12, wherein concentrated radiation with a radiation path lying alongside the thermal opening is deflected by an optical element by means of diffraction into the thermal opening such that the flux of the concentrated radiation is increased.
